(19) United States
(12) Patent Application Publication
(10) Pub. No.: US 2004/0205932 A1
(43) Pub. Date: Oct. 21, 2004

(54) Hinge for doors and similar construction components

(76) Inventor: Harald Sitter, Chables (CH)

Correspondence Address: WENDEROTH, LIND & PONACK, L.L.P., 2033 K STREET N. W., SUITE 800, WASHINGTON, DC, 20006-1021, US

(21) Appl. No.: 10/691,538

(22) Filed: Oct. 24, 2003

(30) Foreign Application Priority Data
Jan. 8, 2003 (CH) 2003 0019/03
Oct. 24, 2002 (CH) 2002 1787/02

(51) Int. Cl. E05D 11/00

(52) U.S. Cl. 16/250

(57) ABSTRACT

The invention concerns a hinge for doors and similar construction components. The hinge (1) can be installed in a recess (27) of the door frame (28), whereby the same receives the hinge (1) completely when the door is closed. In this way the hinge will be completely invisible when the door is closed, and also inaccessible from the outside. This means that the said hinge offers increased resistance against break-ins as well as an improved aesthetic appearance. In order to minimise the size of the required recess the hinge flap (2) that is nearest to the door frame incorporates a flat-angled curved profile, whilst the hinge flap (3) that is nearest to the door is equipped with a profile encloses the hinge axis (4).

The invention concerns a hinge for doors and similar construction components such as for example windows, hatches and suchlike.

Hinges of this type are commonly affixed to the outer surfaces of door and door frame. In many cases this has a number of disadvantages from an aesthetic point of view as well as for reasons of safety with regard to break-ins.

The purpose of the invention is therefore to avoid these disadvantages and to produce a hinge of the type mentioned above that will however be invisible when the door is closed.

This task is solved in accordance with the invention by the fact that the hinge is installed in a recess of the door frame in such a way that the said hinge is received into same completely when the door is closed.

The installed hinge therefore incorporates no projecting, i.e. freely accessible components whatsoever when the door is closed. This improves the aesthetic effect and also increases the resistance against break-in through manipulation of the hinge.

In order to produce as simple a construction as possible the invention envisages that the recess which receives the hinge is formed through the interior space of a hollow profile of the door frame, whereby the hinge can be inserted into the recess through the installation opening of the hollow profile, whose dimensions are suited to those of the hinge dimensions. This is of special advantage when, as often happens, the door frame is constructed from a suitable hollow profile anyway.

In order to minimise the size of the necessary recess the invention envisages that the hinge incorporates two hinge flaps and a hinge bolt which connects the two with one another, whereby the hinge flap nearest to the door frame further incorporates a simple, flat angled flap profile, whilst the hinge flap that is nearest to the door is equipped with a multi-angled flap profile which encloses the hinge bolt.

According to the invention the hinge flap that is nearest to the door frame consists of two flap halves which grippingly surround the hinge flap that is nearest to the door, and which are connected to one another by a narrow connection bridge, and which are further equipped with one fitting flange each.

The invention further envisages that the hinge flap that is nearest to the door can be affixed with the aid of a flange onto an insertion pocket that can be installed into the recess within the door. In this way it will be possible to position the adjustment mechanism that is necessary for the adjustment of the installation position of the door inside the insertion pocket without the same being visible when the door is closed.

According to the invention the recess for the receiving of the insertion pocket is formed through the interior space of the hollow profile of the door, and the insertion pocket can be inserted into the recess through an opening within the hollow profile wall that is dimensioned to suit the outer circumference of the insertion pocket. This embodiment is especially advantageous when, as often happens, the door leaf is equipped with a hollow profile frame anyway.

Further details and features of the invention will be found in the following description with reference to the drawings, whereby:

FIG. 1 shows a frontal view of a hinge according to this invention,

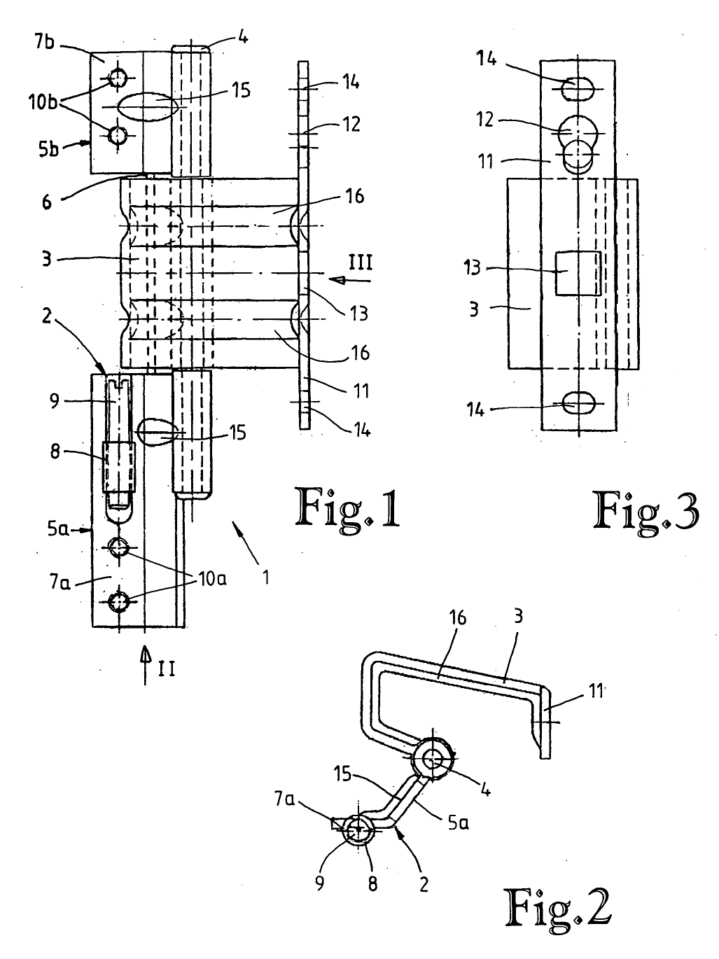

FIG. 2 shows a view of the hinge in the direction of the arrow II illustrated in FIG. 1,

FIG. 3 shows a partial view of the hinge in the direction of the arrow III illustrated in FIG. 1,

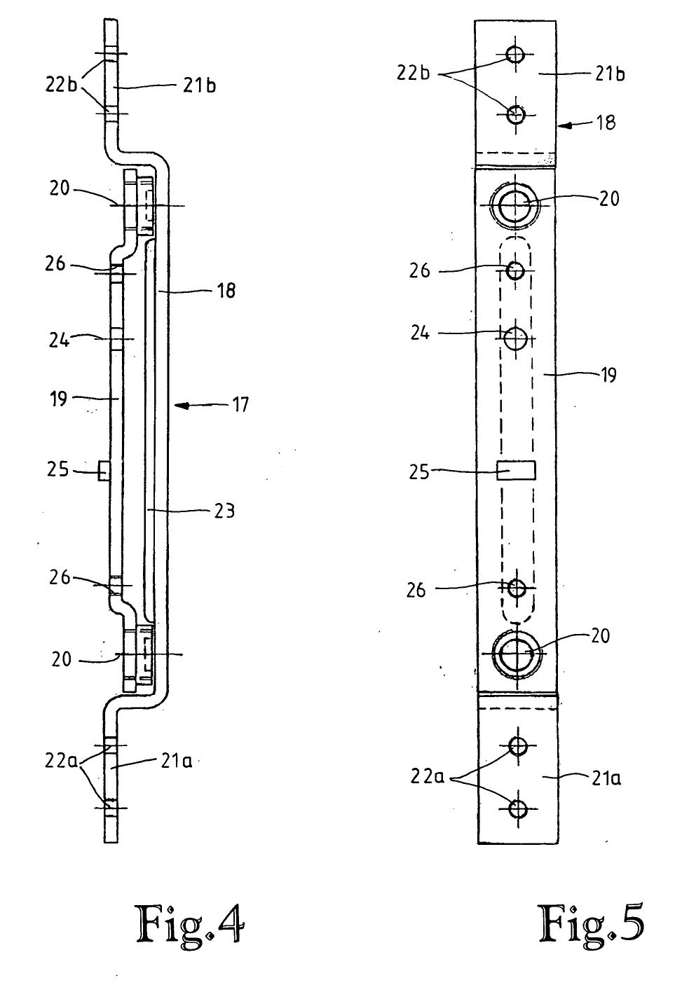

FIG. 4 shows an insertion pocket for the installation of the hinge,

FIG. 5 shows a view of the insertion pocket in the direction of the arrow V illustrated in FIG. 4,

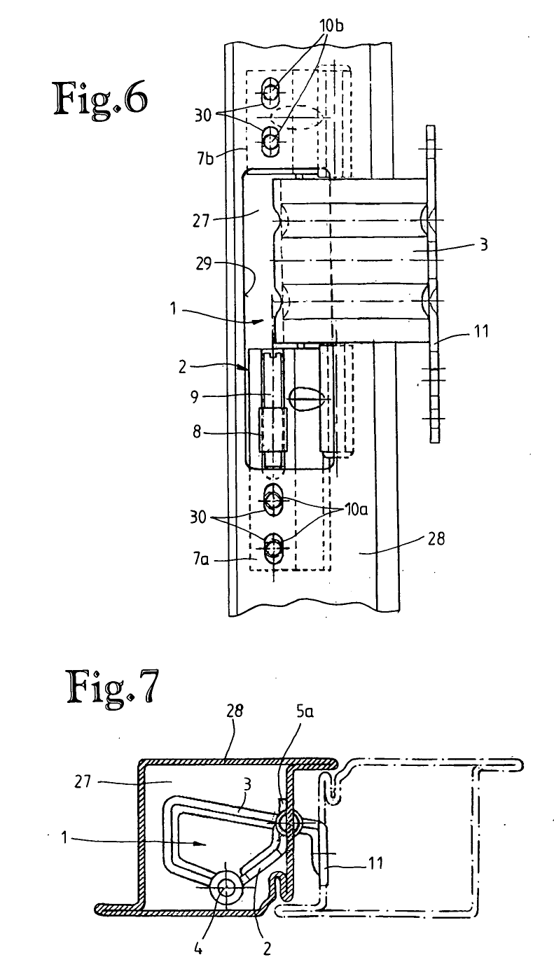

FIG. 6 shows the hinge illustrated in FIG. 1, which has here been installed into a door frame,

FIG. 7 shows the hinge illustrated in FIG. 1, which has here been installed into a door frame and is shown whilst the door is closed,

FIG. 8 shows the installation of the hinge on a door together with the insertion pocket illustrated in FIGS. 4 and 5,

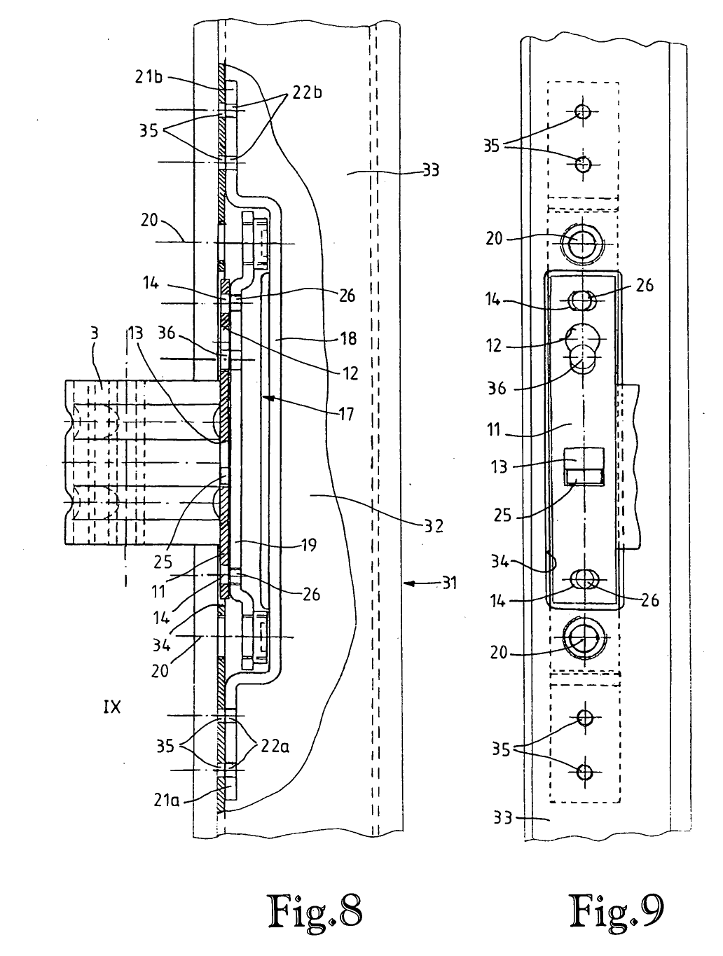

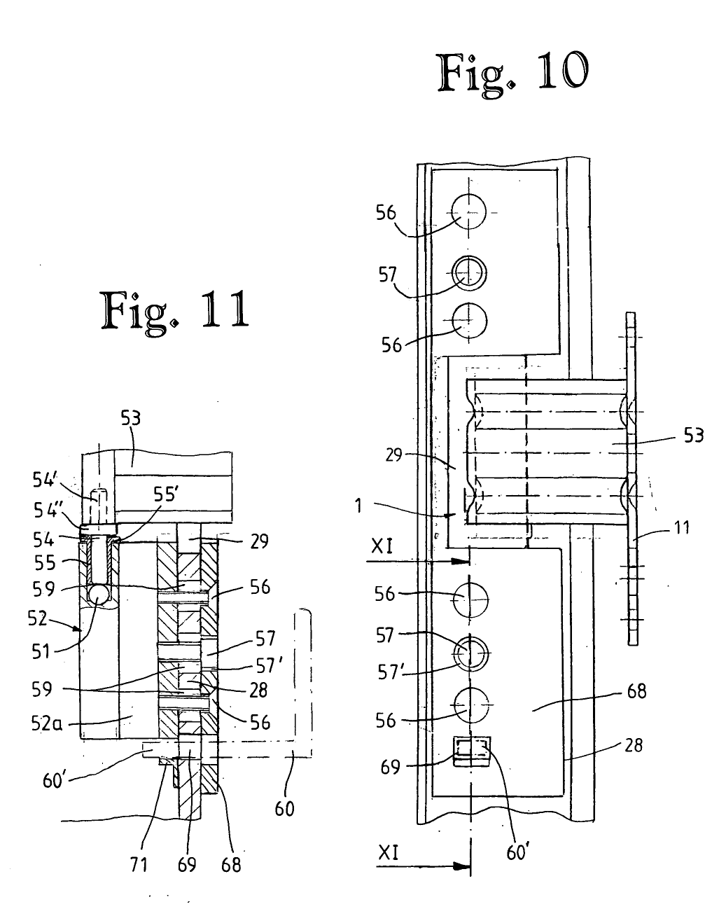

FIG. 9 shows a view of the hinge installation in the direction of the arrow IX illustrated in FIG. 8,

FIG. 10 shows a further embodiment of a hinge according to this invention which has here been installed within a door frame, and

FIG. 11 shows a partial longitudinal cross-section of the hinge along the line XI-XI illustrated in FIG. 10.

The hinge (1) shown in FIGS. 1 to 3 consists of two hinge flaps (2 and 3) which are connected with one another with the aid of a hinge bolt (4).

The hinge flap (2) that is nearest to the door frame incorporates a flat angled simple flap profile. The hinge flap (3) that is nearest to the door is equipped with a multi-angled flap profile which encloses the hinge bolt (4).

The hinge flap (2) that is nearest to the door frame consists of two flap halves (5a, 5b) which grippingly surround the hinge flap (3) that is nearest to the door, whereby the same are connected with one another with the aid of a narrow connection bridge (6), and which are further equipped with one fitting flange (7a, i.e. 7b) each. The flap half (5a) of the hinge flap (2) is equipped with a threaded sleeve (8), into which a threaded bolt (9) is inserted via a thread for the height adjustment of the hinge. The fitting flanges (7a and 7b) incorporate threaded bores (10a, i.e. 10b) for the installation of fitting screws, which are not illustrated here.

The hinge flap (3) that is nearest to the door incorporates a fitting flange (11), which is in turn equipped with a keyhole forming opening (12), a central square opening (13), and longitudinal holes (14) for the fitting screws that are not illustrated here. Ridges (15, i.e. 16) for the increasing of the stiffness of these components are envisaged within the hinge flap (2) as well as within the hinge flap (3). Both hinge flaps can further incorporate gently curved flap profiles instead of the sharply angled profiles.

The insertion pocket (17) illustrated in FIGS. 4 and 5 consists of an internal tab (18) and an external tab (19) resting upon the former, which are screwed to one another with the aid of set screws (20) positioned at their respective ends. The internal tab (18) further incorporates a fitting flange (21a), 21b) with threaded bores (22a, i.e. 22b) for the fitting screws that are not illustrated here. In order to increase the stiffness of the same a ridge (23) is provided. The external tab (19) incorporates a bore (24), into which a set bolt with an eccentric cam is inserted, which is not shown here. It further incorporates a hump-shaped shoulder (25) as well as threaded bores (26), into which the fitting screws which are not illustrated here can be inserted.

FIGS. 6 to 9 show the hinge (1) in its installed position. As is clearly visible in FIGS. 6 and 7 the hinge is installed into the recess (27) of the door frame which is formed by the hollow profile (28). The hinge (1) is inserted through an installation opening (29) of the hollow profile (28) into the recess (27) in this way. Following this the hinge flap (2) is affixed to the hollow profile (28) with screws which are not illustrated here, and which are inserted through the longitudinal holes (30) of the hollow profile (28) and screwed into the threaded bores (10a, 10b) of the fitting flange (7a, i.e. 7b). The installation height of the hinge (1) can be adjusted with the aid of the threaded bolt (9), which is supported against the edge of the hollow profile (28) within the edge area of the installation opening (29). In order to adjust the installation height of the hinge the threaded bolt (9) is screwed into or out of the threaded sleeve (8).

The dimensions of the installation opening (29) are suited to those of the hinge. The installation opening (29) in turn is sized in such a way that the insertion of the hinge as well as the projection and retraction of the hinge flap (3) into and out of the recess (27) are possible on the one hand, whilst the fitting flange (7a and 7b) of the hinge flap (2) fully overlaps the internal wall of the hollow profile (28) on the other hand.

FIGS. 8 and 9 show the fitting of the hinge (1) onto the door (31). As is clearly apparent from FIG. 8 the insertion pocket (17) is installed into the recess (32) of a hollow profile (33) of the door (31). The insertion pocket (17) is inserted into the recess (32) through an opening (34) of the hollow profile (33). The opening (34) is sized to suit the external circumference of the insertion pocket in such a way, that the insertion of the insertion pocket into the recess (32) is possible on the one hand, but that the fitting flange (21a, 21b) of the internal tab (18) completely overlaps the internal wall of the hollow profile (33) on the other hand.

The fitting of the insertion pocket (17) into the hollow profile (33) is effected with the aid of fitting screws which are not illustrated here, which are screwed into the bores (35) of the hollow profile (33) and into the threaded bores (22a, 22b) of the internal tab (18).

In order to install the door the same is initially positioned in relation to the hinge flap (3). This is carried out with the aid of the shoulder (25) that is envisaged upon the external tab (19) as well as with the adjustment bolt with the eccentric cams (36), which is not illustrated here.

For the positioning of the door the shoulder (25) and the eccentric cams (36) are first inserted into the openings (13, i.e. 12) within the fitting flange (11) of the hinge flap (3), whereby the shoulder (25) simultaneously takes up the weight of the door. A turning of the adjustment bolt with the eccentric cams (36) will now enable the comfortable adjustment of the installation position of the door in a traverse direction to the door level.

The fitting of the hinge flap (3) onto the external tab (19) of the insertion pocket (17) is achieved subsequently with the aid of fitting screws that are not illustrated here, and which are inserted through the longitudinal holes (14) within the fitting flange (11) of the hinge flap (3) and screwed into the threaded bores (26) of the external tab (19). The installation position of the door in the direction of the level of the same is adjustable by screwing the set screws (20) either in or out.

It would of course also be possible according to the invention to effect the installation of the hinge in a reversed manner, namely to install the hinge (1) within the recess (32) of the door (31) and to position the insertion pocket (17) within the recess (27) of the door frame (28). As is perfectly obvious one would solve the task of the invention and achieve the advantages according to the same just as well in this way as one would with the embodiment described above.

The FIGS. 10 and 11 show a further embodiment of a hinge (50) according to this invention, with regard to which only the differences in comparison with the embodiment illustrated in FIGS. 1 to 9 will be detailed more fully below, and whereby we refer to the above description for the remainder of the description.

The hinge (50) illustrated here once again consists of a fixed hinge flap (52) incorporating two flap halves (52a) and a moveable hinge flap (53), which are connected with one another with the aid of one hinge bolt (54) each. The hinge bolt (54) is preferably constructed from hardened steel as is clearly visible in FIG. 11, and consists of a pin (54′) that is held within the hinge flap (53), a projecting central ring section (54″) and a pin (54′) which is positioned within a self-greasing bronze bush (55) or similar, and which is located within the hinge flap (52) with its lower facing side of a preferably hardened ball (51). The bronze bush (55) is also equipped with a projecting ring (55′) at its upper side, whereby the same stands in sliding contact with the ring section (54″) of the hinge bolt (54). This means that an installation of a door with a weight of approximately 250 kg will function with relatively little friction and will guarantee a high lifespan. The hinge flap (53) that is shown here only in part is further equipped with the same bearing mechanism at its upper end.

The flap halves (52a) of the hinge flap (52), the lower one of which is illustrated in FIG. 11, are affixed to the internal side of the hollow profile (28). In place of the threaded sleeve (8) and the bolt (9) for the height adjustment of the flap in relation to the frame two countersunk screws (56) and a cylinder head screw (57) between the same are envisaged, which are positioned together upon an axis along the hollow profile (68), as well as a U-shaped cover plate (68), which abuts against the hollow profile (28) on the outside of the same. These three screws (56, 57) for a flap half (52a) are screwed into this flap half (52a) with the aid of the relevant threads in their installed condition. The hollow profile (28) however incorporates longitudinally orientated longitudinal grooves (59), and the cover plate (68) incorporates suitable cut-outs for the cylinder head screw (57) as well as a bore (57′), which is only slightly larger than the external diameter of the screw head.

According to the invention an opening (69) is positioned below the hinge (52, 53), whereby the same extends straight across the hollow profile (28) and the cover plate (68), and an angled overlay (71), which extends against the inside of the profile at the lower end of this opening. This opening (69) serves for the receiving of a lifting key (60) for the installation, i.e. for the height adjustment of the hinge in relation to the hollow profile, whereby the lower flap half (52a) lies immediately next to the upper end of the opening, so that the flap half (52a) can be adjusted with this lifting key.

This lifting key (60) which serves as a tool is formed in such a way that the hinge (52, 53) can be adjusted with the same in relation to the hollow profile (28) through manual manipulation. To this purpose the said lifting key (60) consists of a square section (60′) for the lifting of the flap half (52a) of the hinge, and a grip element for the manual activation of the key which preferably projects at a right angle from the same square section (60′).

The fitting flange (11) preferably incorporates two key-shaped openings (12) instead of the longitudinal hole (14) and the square opening (13) as opposed to that illustrated in FIG. 3. In this way the door can be hung on the fitting flanges quite comfortably and easily.

It is further possible to effect a simple installation of the hinge (50) within the hollow profile (28) in this way. Firstly the flap halves (52a) can be individually inserted into the hollow space through the installation opening (29), where they are initially and provisionally fastened by one cylinder head screw (57) each, whereby a lifting key is inserted into the opening (69), so that the flap halves will not fall into the fixed profile (28). The turnable hinge flap (53) is then inserted into the flap halves (52a, 52b) together with the hinge bolt (54) affixed to the same, so that the same is turnably affixed to the same. Following this installation of the hinge flap (53) the height of the door can be adjusted, whereby the six screws (56, 57) are initially loosened, and whereby the hinge flaps (52, 53) are then all together adjusted upwards or downwards with the aid of the lifting key which has been inserted into the opening (69), and whereby the screws are then fastened whilst the key is held firmly. For a cross-directional adjustment of the door the position of the relevant screws of the fitting flange (11) can be changed, as has already been described in more detail above.

It is possible to open a door as far as 115° and more with the hinges of this invention. They further guarantee a load bearing capacity of up to 250 kg and more. The hinge also enables an three-dimensional adjustment of the door in relation to the frame, namely vertically upwards, i.e. downwards, horizontally to the left, i.e. to the right, and horizontally towards the front, i.e. towards the back. This enables a simple and accurate alignment of the door to the frame.

1. Hinge for doors and similar construction components, with which a door (31) which has been installed within a door frame can be turned, whereby the same incorporates one hollow profile (28, 33) with one recess (27, 32) each, wherein the hinge (1, 50) can be installed within the recess (27) of the door frame, and in that the hinge is completely received into the door when the same is closed, so that the same hinge is completely invisible when the door (31) is closed.

2. Hinge according to claim 2, wherein the hinge (1) can be inserted into the recess (27) through an installation opening (29) located within the hollow profile (28), the dimensions of which are sized to suit those of the hinge.

3. Hinge according to claim 1 wherein the hinge is equipped with two hinge flaps (2, 3) which are connected with one another with the aid of a hinge bolt (4), one of which incorporates a flat-angled simple flap profile on the hinge flap (2) that is nearest to the door frame, whilst the hinge flap (3) that is nearest to the door is equipped with a multi-angled flap profile which encloses the hinge bolt (4).

4. Hinge according to claim 3, wherein the hinge flap (2) that is nearest to the door frame can be flanged onto the internal wall of the hollow profile (28) of the door frame.

5. Hinge according to claim 3 wherein one of the hinge flaps is positioned in a height-adjustable manner within the said hollow profile.

6. Hinge according to claim 3, wherein one of the hinge flaps (2) consists of two flap halves (5a, 5b) which are located on both side of the other hinge flap (3), whereby the said hinge flaps (2, 3) are rotationally connected with one another with the aid of the hinge bolt (4).

7. Hinge according to claim 3, wherein the hinge flap (3) that is nearest to the door can be flanged onto an insertion pocket (17) which can be installed into the recess (32) of the door (31).

8. Hinge according to claim 7, wherein the recess (32) is formed by the internal space of a hollow profile (33) of the door (31), and in that the insertion pocket (17) can be inserted through an opening (34) of the hollow profile (33), the size of which is suited to the dimensions of the relevant outside diameter of the insertion pocket, into the recess (32).

9. Hinge according to claim 7 wherein the insertion pocket (17) consists of an internal tab (18) and an external tab (19) resting upon the former, which are screwed to one another with the aid of set screws (20) positioned at their respective ends for the adjustment of the door in the direction of the door level, whereby the internal tab (18) can be flanged onto the internal wall of the hollow profile (33) of the door, and whereby the external tab (19) is equipped with an adjustment bolt with an eccentric cam (36) which is rotationally positioned within the insertion pocket (17), for the adjustment of the door across the direction of the door level, whereby the same co-operates with a keyhole-shaped opening (12) within the fitting flange (11) of the hinge flap (3) that is nearest to the door.

10. Hinge according to claim 1, wherein the fitting of the flap halves (52a, 52b) that the one of the hinge flaps that can be installed inside the hollow profile (28) further incorporates a cover plate (68) which lies externally and adjacent to the hollow profile (28) as well as the relevant fittings, which enable a simple and height-adjustable installation of the hinge flap onto the hollow profile.

11. Hinge according to claim 1, wherein an opening (69) is positioned below the hinge (52, 53), whereby the same extends straight across the hollow profile (28) and the cover plate (68), whereby the same receives a lifting key for the installation, i.e. for the height adjustment of the hinge (52, 53) within, i.e. in relation to the hollow profile.

12. Tool for the adjustment of a hinge according to claim 11, wherein the said tool takes the form of a lifting key with which the hinge (52, 53) can be manually adjusted in relation to the hollow profile (28).

13. Tool according to claim 12, wherein the lifting key consists of a square section (60′) for the lifting of the flap half (52a) of the hinge, and a grip element for the manual activation of the key which preferably projects at a right angle from the same square section (60′).
